(19) United States
(12) Patent Application Publication
(10) Pub. No.: US 2017/0245538 A1
(43) Pub. Date: Aug. 31, 2017

(54) SOLID DISPERSION OF AMIDE FLAVOR COMPOUNDS

(71) Applicant: Firmenich SA, Geneva 8 (CH)

(72) Inventors: Pascal BEAUSSOUBRE, Geneva (CH); Wolfgang FIEBER, Geneva (CH); Stephanie BUDIJONO, New York, NY (US); Valery NORMAND, Plainsboro, NJ (US)

(73) Assignee: Firmenich SA, Geneva 8 (CH)

(21) Appl. No.: 15/500,745

(22) PCT Filed: Jul. 29, 2015
(86) PCT No.: PCT/EP2015/067323

§ 371 Date: Jan. 31, 2017

Related U.S. Application Data
(60) Provisional application No. 62/031,860, filed on Aug. 1, 2014.

(51) Int. Cl. A23L 27/00; A23L 27/20

(52) U.S. Cl. CPC A23L 27/88; A23L 27/204; A23V 2002/00

(57) ABSTRACT

Provided herein are methods of improving the dissolution rate in water of a compound of Formula (F) in the form of any one of its stereoisomers or a mixture thereof, and wherein n is an integer from 0 to 2; the dotted line represents a carbon-carbon single or double bond; and each of R¹ to R⁴, when taken independently from each other, represents a hydrogen atom or represents a R⁵ or OR⁵ group, R⁵ representing a C₁ to C₅ alkyl group; and optionally one of the groups R₁ to R₄ represents —OH; and/or when R₁ and R₂ are taken together, and/or R₃ and R₄ are taken together, represent a OCH₂O group, provided said groups taken together are adjacent substituents of the phenyl group.

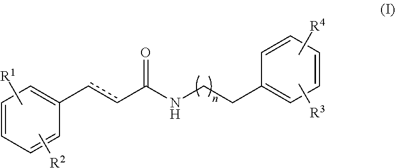

### FIELD

The field is related to a delivery system for poorly water soluble flavors or taste modifiers that are amides.

### BACKGROUND

Amides described in Patent Application Number PCT/EP2012/060641, incorporated by reference in its entirety herein, are poorly soluble in water and difficult to solubilize. Hence, it would be advantageous to provide a means for increasing the dissolution rates of these compounds in water.

### SUMMARY

Provided herein is a method of improving the dissolution rate in water of a compound of

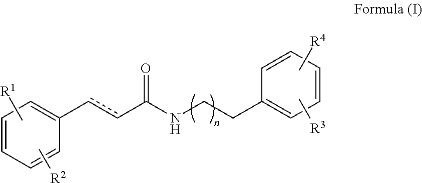

in the form of any one of its stereoisomers or a mixture thereof, and wherein n is an integer from 0 to 2; the dotted line represents a carbon-carbon single or double bond; and each of R¹ to R⁴, when taken independently from each other, represents a hydrogen atom or represents a R⁵ or OR⁵ group, R⁵ representing a C₁ to C₅ alkyl group; and optionally one of the groups R₁ to R₄ represents OH; and/or when R₁ and R₂ are taken together, and/or R₃ and R₄ are taken together, represent a OCH₂O group, provided said groups taken together are adjacent substituents of the phenyl group comprising:
a. dissolving the compound in a water miscible solvent at high concentration;
b. mixing the solution with an aqueous solution in the presence of a water soluble stabilizer to form a solvent mixture comprising a suspension of crystals of the compound; and
c. removing the solvent to obtain a solid dispersion comprising a particle comprised of the compound coated by the stabilizer.

### DETAILED DESCRIPTION

In one embodiment, the solvent comprises a water miscible, volatile organic solvent. In a particular embodiment the solvent is selected from the group consisting of propylene glycol, benzyl alcohol, propanol, ethanol, triacetin, and ethyl citrate. In a particular embodiment, the solvent is selected from the group consisting of propylene glycol and propanol. In a more particular embodiment the solvent is propylene glycol. In another embodiment, the solvent is propanol. In another embodiment the solvent is a mixture of two or more water miscible, volatile organic solvents. A compound of Formula (I) is dissolved in the water miscible volatile organic solvent at a concentration from about 0.1% w/w to about 60% w/w, more particularly at a concentration from about 1% w/w to about 20% w/w, and even more particularly from about 1% w/w to about 10% w/w.

In another embodiment, the solvent phase is defined as follows: A solvent in which the compound can be dissolved at high concentrations (solubility>1% w/w at a temperature varying from 15° C. to 90° C.).

The anti-solvent or non-solvent is ideally mixed at a ratio to the solvent phase that allows for rapid precipitation of the hydrophobic active.

In one embodiment, a suitable stabilizer for the particles described herein comprises a highly water soluble food grade polymer or emulsifier. In another embodiment a stabilizer is chosen from the group consisting of gelatin, zein, proteins, vegetable protein, casein, starch, pectin, octenyl succinate starch, gum Arabic, saponin and sucrose esters. In a particular embodiment gelatin is selected from the group consisting of chicken, fish and beef gelatin. In another embodiment the stabilizer is a mixture of two or more water soluble food grade polymers or emulsifier. The stabilizer is added to water at a concentration from about 0.001% w/w to about 20% w/w, more particularly at a concentration from about 0.001% w/w to about 10% w/w, even more particularly from about 0.1% w/w to about 10% w/w. In one embodiment, the stabilizer may be added at a concentration sufficient to allow for the complete protection of the hydrophobic active.

In one embodiment the aqueous solution is buffered at a specific pH value ranging from 0 to 14.

In one embodiment, the water miscible solvent with the dissolved compound of Formula (I) is added to the aqueous solution containing stabilizer. The concentration of a compound of Formula (I) in the solvent mixture needs to be greater than its solubility limit to allow for the precipitation of the compound of Formula (I).

In another embodiment a particle is provided, prepared and/or obtainable by the methods described herein. In a particular embodiment provided herein is a particle comprising a crystallized compound of Formula (I) coated with gelatin wherein the particle has an average length of about 1 μm to about 10 μm and an average width of about 0.3 μm to about 3 μm.

In a further embodiment particle is provided in the substantial absence of a block copolymer, particularly less than 0.5% of a block copolymer, more particularly less than 0.1% of a block copolymer and even more particularly less than 0.01% of a block copolymer.

In one embodiment a particle provided herein dissolves in water at a rate of up to 30 ppm/min at a temperature of about 60° C., particularly at a rate of 10 ppm/min at a temperature of about 60° C.

In one aspect, the methods provided herein provide increased dissolution rates of a compound of Formula (I) in water. In another aspect, the methods provided herein may further enhance the performance of a compound of Formula (I) as flavors or taste modulators in food and beverage applications. While not wishing to be bound to any theory, it is postulated that the solid dispersion is obtained via anti-solvent precipitation. The anti-solvent here would, in one embodiment, be water which causes the compound of Formula (I) to precipitate as crystals from the solvent mixture. When the solvent mixture containing the water is evaporated, the stabilizer coats the crystals to form particles in a powder form wherein the powder, when added to an aqueous solution, such as a soups or beverages, allows for an increase in the dissolution kinetics of the compound of Formula (I). Hence, an embodiment herein involves the coating of a compound of Formula (I) also referred to an active ingredient.

The method provided here provides the dissolution of an active ingredient in the solvent phase at a high concentration which allows rapid, and in some embodiments the instantaneous, homogenous precipitation of a compound of Formula (I) in the anti-solvent phase. This also contributes to a high loading of a compound of Formula (I) into a powder mixture than would otherwise be obtained from simply spray drying a solution of a compound of Formula (I).

A drying step removes most of the solvent and allows the creation of a dry product which can be re-dispersed in water.

The final weight ratio in the solid, dry powder of a compound of Formula (I) and the stabilizer is comprised between 100:1 and 1:100, more preferably between 10:1 and 1:9, even more preferably between 5:1 and 1:5. In one particular embodiment the ratio is 1:3.

The types of end products where this invention is useful are:
stocks for soup,
any food and beverages applications that require incorporation of hydrophobic actives and fast dissolution and higher active concentration in water.

The compounds and solutions provided herein can be used alone or in mixtures and provide a strong kokumi or umami taste at exceptionally low levels.

Provided herein is the use of the solutions, compounds and powder provided as a taste-conferring or enhancing ingredient, and in particular to impart or reinforce kokumi or umami taste.

In a particular embodiment of the invention, said compound (I) is used to impart or reinforce kokumi or umami taste as well as to enhance the saltiness and/or savory perception of a flavor.

Particular applications provided herein are uses to impart or enhance the kokumi or umami taste in savory flavors, such as beef, chicken, pork, and seafood. Surprisingly, in seafood applications such as surimi, or seafood bouillons or snack flavors, compounds according to formula (I) are also found to enhance the perception of sweetness and longevity of the flavor. By contrast, in beef flavors, the compounds according to formula (I) are found to enhance perception of fattiness and tallow notes. Additionally we found that said compounds can increase juiciness in meat based products.

Suitable foodstuff bases, e.g. foods or beverages, can be fried or not, as well as frozen or not, low fat or not, marinated, battered, chilled, dehydrated, instant, canned, reconstituted, retorted or preserved. Typical examples of said foodstuff bases include:
a seasonings or condiment, such as a stock, a savory cube, a powder mix, a flavored oil, a sauce (e.g. a relish, barbecue sauce, a dressing, a gravy or a sweet and/or sour sauce), a salad dressing or a mayonnaise;
a meat-based product, such as a poultry, beef or pork based product, a seafood, surimi, or a fish sausage;
a soup, such as a clear soup, a cream soup, a chicken or beef soup or a tomato or asparagus soup;
a carbohydrate-based product, such as instant noodles, rice, pasta, potatoes flakes or fried, noodles, pizza, tortillas, wraps;
a dairy or fat product, such as a spread, a cheese, or regular or low fat margarine, a butter/margarine blend, a butter, a peanut butter, a shortening, a processed or flavored cheese;
a savory product, such as a snack, a biscuit (e.g. chips or crisps) or an egg product, a potato/tortilla chip, a microwave popcorn, nuts ,a pretzel, a rice cake, a rice cracker, etc;
an imitation products, such as a dairy (e.g a reformed cheese made from oils, fats and thickeners) or seafood or meat (e.g. a vegetarian meat replacer, veggie burgers) analogue; or
a pet or animal food.

Particular foodstuffs in which the compound according to formula (I) finds utility include those having topnotes such as seafood, beef, chicken, vegetables, cheese, fat, tallow and/or marrow are important.

For the sake of clarity, it has to be mentioned that, by “foodstuff” we mean here an edible product, e.g. a food or a beverage. Therefore, a flavored article according to the invention comprises one or more compounds according to formula (I), as well as optional benefit agents, corresponding to taste and flavor profile of the desired edible product, e.g. a savory cube. The nature and type of the constituents of the foodstuffs or beverages do not warrant a more detailed description here, the skilled person being able to select them on the basis of his general knowledge and according to the nature of said product.

In one embodiment, the compound may be initially dissolved at high concentration in the solvent. This allows rapid precipitation which leads to a more homogeneous suspension and better polymer protection. An example of the hydrophobic active is (E)-3-(3,4-dimethoxyphenyl)-N-(4-methoxyphenethyl)acrylamide.

The examples provided below are not limiting and are for illustrative purposes only.

### EXAMPLES

### Example 1

4 wt % (E)-3-(3,4-dimethoxyphenyl)-N-(4-methoxyphenethyl)acrylamide is dissolved in propylene glycol at 80° C. and added into room temperature 1 wt % of beef gelatin solution in water, to yield 1:12 ratio of (E)-3-(3,4-dimethoxyphenyl)-N-(4-methoxyphenethyl)acrylamide to Gelatin solution. The solution is lyophilized to yield a dry product which can be re-suspended in water.

### Example 2

4 wt % (E)-3-(3,4-dimethoxyphenyl)-N-(4-methoxyphenethyl)acrylamide is dissolved in propylene glycol at 80° C. and added into room temperature 1 wt % of beef gelatin solution in water, to yield 1:9 ratio of (E)-3-(3,4-dimethoxyphenyl)-N-(4-methoxyphenethyl)acrylamide to gelatin solution. The solution is lyophilized to yield a dry product which can be re-suspended in water.

### Example 3

4 wt % (E)-3-(3,4-dimethoxyphenyl)-N-(4-methoxyphenethyl)acrylamide is dissolved in propylene glycol at 80° C. and added into room temperature 1 wt % of chicken gelatin solution in water, to yield 1:9 ratio of (E)-3-(3,4-dimethoxyphenyl)-N-(4-methoxyphenethyl)acrylamide to Gelatin solution. The solution is lyophilized to yield a dry product which can be re-suspended in water.

### Example 4

A solution of (E)-3-(3,4-dimethoxyphenyl)-N-(4-methoxyphenethyl)acrylamide 3 % w/w in n-propanol is prepared at 50° C. Twenty-four (24) g of the warm solution is mixed rapidly (1 minute) with 200 g of an aqueous phase containing 1% of gum Arabic (superstab gum). Precipitation of (E)-3-(3,4-dimethoxyphenyl)-N-(4-methoxyphenethyl)acrylamide occurs immediately, and crystals in the form of elongated platelets are formed. The solvent is removed at 50° C. under reduced pressure, and the solid dispersion is subsequently dried under vacuum. The loading of (E)-3-(3,4-dimethoxyphenyl)-N-(4-methoxyphenethyl)acrylamide in the final powder is 25% w/w.

### Example 5

The dissolution kinetics of example 4 in water was tested. A final concentration of (E)-3-(3,4-dimethoxyphenyl)-N-(4-methoxyphenethyl)acrylamide of 20 ppm dissolved in water was targeted. Eighty (80) mg of a solid dispersion of (E)-3-(3,4-dimethoxyphenyl)-N-(4-methoxyphenethyl)acrylamide and gum arabic was dispersed in 1L of milli Q water heated at 60° C. The solution was stirred mechanically by the means of a paddle stirrer at 200 rpm. The dissolution process was followed on-line by monitoring the UV signal of dissolved (E)-3-(3,4-dimethoxyphenyl)-N-(4-methoxyphenethyl)acrylamide with UV/Vis spectroscopy using a fiber optic probe from Ocean Optics. The powder was entirely dissolved after 2 minutes. The maximum dissolution rate during the process was 28 ppm/minute.

### Example 6

Comparative example: (E)-3-(3,4-dimethoxyphenyl)-N-(4-methoxyphenethyl)acrylamide pure. A final concentration of (E)-3-(3,4-dimethoxyphenyl)-N-(4-methoxyphenethyl)acrylamide of 20 ppm dissolved in water was targeted. Twenty (20) mg of the pure (E)-3-(3,4-dimethoxyphenyl)-N-(4-methoxyphenethyl)acrylamide were dispersed in 1L of milli Q water heated at 60° C. The dissolution process yielded 50% of the target concentration of 20 ppm (10 ppm) after 78 minutes. The target concentration could not be achieved after 6 hours. The concentration of dissolved (E)-3-(3,4-dimethoxyphenyl)-N-(4-methoxyphenethyl)acrylamide after 6 hours was 15 ppm (75% of target).

1. A method of improving the dissolution rate in water of a compound of Formula (I) 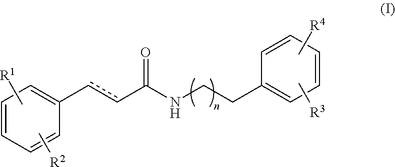
in the form of any one of its stereoisomers or a mixture thereof, and wherein n is an integer from 0 to 2; the dotted line represents a carbon-carbon single or double bond; and each of R¹ to R⁴, when taken independently from each other, represents a hydrogen atom or represents a R⁵ or OR⁵ group, R⁵ representing a C₁ to C₅ alkyl group; and optionally one of the groups R₁ to R₄ represents —OH; and or when R₁ and are taken together, author R₃ and R₄ are taken together, represent a OCH₂O group, provided said groups taken together are adjacent substituents of the phenyl group comprising:
a. dissolving the compound in a water miscible solvent at a high concentration;
b. mixing the solution with an aqueous solution in the presence of a water soluble stabilizer to form a solvent mixture comprising a suspension of crystals of the compound; and
c. removing the solvent to obtain a solid dispersion of the compound coated by the stabilizer.

2. The method of claim 1 wherein the solvent of step (a) is chosen among water miscible, volatile organic solvents.

3. The method of claim 1 wherein the stabilizer is selected from the group consisting of gelatin, zein, proteins, vegetable protein, casein, starch, pectin, octenyl succinate starch, gum Arabic, saponin and sucrose ester.

4. The method of claim 1 wherein the compound is represented by a compound of Formula (I) 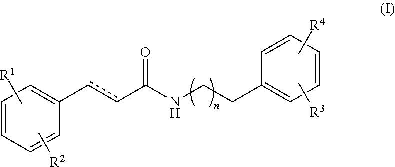
in the form of any one of its stereoisomers or a mixture thereof, and wherein n is an integer from 0 to 2; the dotted line represents a carbon-carbon single or double bond; and each of R¹ to R⁴, when taken independently from each other, represents a hydrogen atom or represents a R⁵ or OR⁵ group, R⁵ representing a C₁ to C₅ alkyl group; and optionally one of the groups R₁ to R₄ represents under when R₁ and R₂ are taken together, and/or R₃ and R₄ are taken together, represent a OCH₂O group, provided said groups taken together are adjacent substituents of the phenyl group.

5. The method as recited in claim 2 wherein the compound is a compound of formula (II) 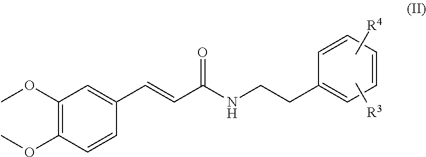
in the form of any one of its stereoisomers or a mixture thereof, and wherein each of R³ or R⁴, taken independently from each other, represents a hydrogen atom or represents a R⁵ or OR⁵ group, R⁵ representing a C₁ to C₅, or even a C₁ to C₃ alkyl group.

6. The method as recited in claim 1 wherein the compound is selected from the group consisting (E)-3-(3,4-dimethoxyphenyl)-N-(4-methoxyphenethyl)acrylamide, (E)-3-(3,4-dimethoxyphenyl)-N-(3-methoxyphenethyl)acrylamide (E)-3-(3,4-dimethoxyphenyl)-N-(3-ethoxyphenethyl)acrylamide, (E)-3-(3,4-dimethoxyphenyl)-N-(3-propoxyphenethyl)acrylamide (E)-3-(3,4-dimethoxyphenyl)-N-(4-isopropoxyphenethyl)acrylamide, (E)-3-(3,4-dimethoxyphenyl)-N-(4-ethylphenethyl)acrylamide (E)-3-(3,4-dimethoxyphenyl)-N-(3,4-dimethylphenethyl)acrylamide, (E)-3-(3,4-dimethoxyphenyl)-N-(4-isopropylphenemethyl)acrylamide or (E)-3-(3,4-dimethoxyphenyl)-N-(3-methylphenethyl)actylamide (referenced in the Examples as Amide 17).

7. The method as recited claim 1 wherein the solid dispersion is lyophilize to form solid particles.

8. The method as recited in claim 1 wherein the solid dispersion te is spray dried to form solid particles.

9. The method as recited in claim 1 where in the solvent is selected from the group consisting of propylene glycol, benzyl alcohol, propanol, ethanol, triacetin, and ethyl citrate.

10. The method as recited in claim 1 wherein the gelatin is selected from the group consisting of chicken, fish and beef gelatin.

11. A particle prepared or obtainable according to claim 1.

12. A particle comprising a crystallized compound as defined in claim 1 coated with gelatin wherein the particles have a length of about 1 μm to about 10 μm and a width of about 0.3 μm to about 3 μm and wherein the particles are provided in the absence of a block copolymer and dissolve in water at a rate up to 30 ppm/min.

13. The particle as recited in claim 12 where the particles dissolved at a rate of up to 10 ppm/min at a temperature of about 60° C.
